(19) United States
(12) Patent Application Publication
(10) Pub. No.: US 2021/0087997 A1
(43) Pub. Date: Mar. 25, 2021

(54) PISTON FOR INTERNAL COMBUSTION ENGINE

(71) Applicant: GM GLOBAL TECHNOLOGY OPERATIONS LLC, Detroit, MI (US)

(72) Inventors: Vicent Domenech-Llopis, Rochester Hills, MI (US); Ramachandra Diwakar, Troy, MI (US)

(21) Appl. No.: 16/580,800

(22) Filed: Sep. 24, 2019

(51) Int. Cl. F02F 3/26; F02B 23/06; F02F 3/28

(52) U.S. Cl. CPC F02F 3/26; F02F 3/28; F02B 23/0672

(57) ABSTRACT

A piston for an internal combustion engine includes a piston wall defining an outer perimeter of the piston, and a piston face located at an end of the piston wall. The piston face includes a radially-extending outer face, and a combustion bowl formed therein and recessed from the outer face. The combustion bowl includes an upper bowl including a flat upper bowl radial surface recessed from the outer face a distance in the range from 3.5 to 4.5 millimeters, and a lower bowl including a lower bowl surface recessed to a maximum bowl depth from the flat upper bowl axial surface in the range from 10.4 to 13.4 millimeters. The piston face is axisymmetric about a piston central axis.

### INTRODUCTION

The subject disclosure relates generally to an internal combustion engine and more particularly to a piston for an internal combustion engine.

Reciprocating internal combustion engines generally use pistons that oscillate in the cylinder. The piston functions as a sliding plug that fits closely inside the bore of a cylinder. Essentially, the piston is driven alternately in the cylinder. A burning of a mixture of fuel and air above a piston generates gas pressure from compressed and ignited combustion gases. This pressure forces the piston in a downward direction. As this happens, the piston transmits the force of expanding combustion gases through the piston pin to a connecting rod. The piston is attached to the connecting rod, and thus to a crankshaft, transferring reciprocating motion to rotating motion.

The piston has a piston face that along with the cylinder in which the piston resides defines a combustion chamber for the mixture of fuel and air. The shape of the piston face imparts properties to the combustion chamber and has an effect on aspects of engine performance, such as engine emissions, torque performance, power, efficiency/fuel economy and the like.

Accordingly, it would be desirable in the industry to provide a piston that improves one or more such aspects of engine performance, is lightweight and at a relatively low cost.

### SUMMARY

In one embodiment, a piston for an internal combustion engine includes a piston wall defining an outer perimeter of the piston, and a piston face located at an end of the piston wall. The piston face includes a radially-extending outer face, and a combustion bowl formed therein and recessed from the outer face. The combustion bowl includes an upper bowl including a flat upper bowl radial surface recessed from the outer face a distance in the range from 3.5 to 4.5 millimeters, and a lower bowl including a lower bowl surface recessed to a maximum bowl depth from the flat upper bowl axial surface in the range from 10.4 to 13.4 millimeters. The piston face is axisymmetric about a piston central axis.

Additionally or alternatively, in this or other embodiments the upper bowl radial surface is orthogonal to the piston central axis.

Additionally or alternatively, in this or other embodiments the lower bowl is defined by a lower bowl surface including a concave surface portion, and a convex surface portion extending from the concave surface portion toward the piston central axis. The maximum bowl depth is located in the concave surface portion.

Additionally or alternatively, in this or other embodiments the lower bowl surface is connected to the upper bowl axial surface via a bowl transition radius in the range of 0.32 to 0.52 millimeters.

Additionally or alternatively, in this or other embodiments the intersection of the bowl transition radius to the upper bowl axial surface defines a lower bowl radius from the piston central axis in the range of 28.4 to 30.4 millimeters.

Additionally or alternatively, in this or other embodiments the concave surface portion extends radially outwardly from the piston central axis further that the lower bowl radius.

Additionally or alternatively, m this or other embodiments the radially-extending outer face intersects the upper bowl at an upper bowl edge, the upper bowl edge defining an upper bowl radius in the range of 40 to 42 millimeters relative to the piston central axis.

Additionally or alternatively, in this or other embodiments an upper bowl axial surface extends from the upper bowl edge toward the upper bowl radial surface and is connected thereto by an upper connector radius in the range of 0.25 to 0.45 millimeters.

Additionally or alternatively, in this or other embodiments the lower bowl has a lower bowl center located at the piston central axis, the lower bowl center having a center depth relative to the upper bowl axial surface in the range of 3.71 to 5.71 millimeters.

Additionally or alternatively, in this or other embodiments the radially-extending outer face extends radially from the combustion bowl to the piston wall and has a radial width in the range of 9.5 millimeters to 11.5 millimeters.

Additionally or alternatively, in this or other embodiments the radially-extending outer face is orthogonal to the piston central axis.

Additionally or alternatively, in this or other embodiments the combustion bowl is defined by revolving a set of coordinate points 360 degrees about the piston central axis, the set of coordinate points defined m Table 1.

In another embodiment, a piston includes a piston face, and a combustion bowl formed in the piston face and recessed therefrom. The combustion bowl includes an upper bowl having an upper bowl radius at the piston face in the range of 40 to 42 millimeters, and a lower bowl recessed from the upper bowl having a lower bowl radius at the upper bowl in the range of 28.4 to 30.4 millimeters.

Additionally or alternatively, in this or other embodiments the upper bowl includes a flat upper bowl radial surface recessed from the piston face a distance in the range from 3.5 to 4.5 millimeters.

Additionally or alternatively, in this or other embodiments the upper bowl radial surface is orthogonal to the piston central axis.

Additionally or alternatively, in this or other embodiments the lower bowl includes a lower bowl surface recessed to a maximum bowl depth from upper bowl in the range from 10.4 to 13.4 millimeters.

Additionally or alternatively, in this or other embodiments the lower bowl surface includes a concave surface portion, and a convex surface portion extending from the concave surface portion toward the piston central axis. The maximum bowl depth is located in the concave surface portion.

Additionally or alternatively, in this or other embodiments the lower bowl surface is connected to the upper bowl via a bowl transition radius in the range of 0.32 to 0.52 millimeters.

Additionally or alternatively, in this or other embodiments the lower bowl has a lower bowl center located at the piston central axis, the lower bowl center having a center depth relative to the upper bowl radial surface in the range of 3.71 to 5.71 millimeters.

In yet another embodiment, a piston includes a piston wall defining an outer perimeter of the piston and a piston face located at an end of the piston wall. The piston face includes an outer face, and a combustion bowl formed therein and recessed from the outer face. The combustion bowl is defined by revolving a set of coordinate points 360 degrees about a piston central axis. The set of coordinate points are defined in Table 1.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a partial cross-sectional view of an embodiment of a piston assembly;

FIG. 2 is a perspective view of an embodiment of a piston; and

FIG. 3 is a cross-sectional view of a combustion bowl of an embodiment of a piston.

### DETAILED DESCRIPTION

The following description is merely exemplary in nature and is not intended to limit the present disclosure, its application or uses. It should be understood that throughout the drawings, corresponding reference numerals indicate like or corresponding parts and features.

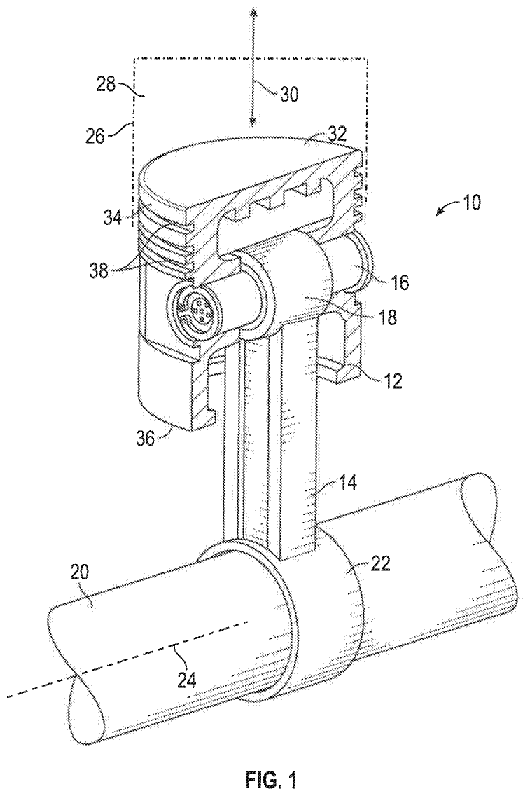

In accordance with an exemplary embodiment, FIG. 1 illustrates a perspective view of an embodiment of a piston assembly 10. The piston assembly 10 includes a piston 12 connected to a connecting rod 14 via a piston pin 16. The connecting rod 14 is coupled to the piston 12 at a proximate end 18 while the connecting rod 14 is coupled to a crank shaft journal 20 of a crank shaft (not shown) at a distal end 22, opposite the proximate end 18. The piston 12 resides in a cylinder 26, defining a combustion chamber 28. As the crank shaft rotates about a shaft axis (not shown), the connecting rod 14 urges motion of the piston 12 along a combustion chamber axis 30. The piston 12 includes a piston face 32, and a piston wall 34 extending from the piston face 32 generally in a direction along the combustion chamber axis 30 toward the crank shaft journal 20 and a piston base 36. In some embodiments, the piston wall 34 includes one or more circumferentially-extending grooves 38 into which piston seals (not shown) may be installed to provide sealing between the cylinder 26 and the piston wall 34. The piston wall 34 defines an outer perimeter of the piston 12, and the piston face 32 is located at a remote end of the piston wall 34, relative to the crank shaft journal 20 location.

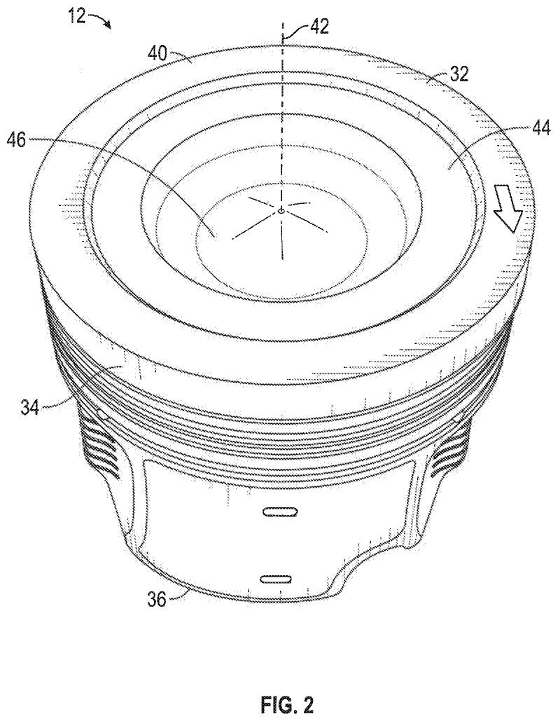

Referring to the perspective view of FIG. 2, the piston face 32 includes a radially-extending outer face 40 defining a radially outboard portion of the piston face 32 relative to a piston central axis 42. In some embodiments, the outer face 40 is flat and orthogonal to the piston central axis 42. Further, in some embodiments, the outer face 40 abuts the piston wall 34 and is orthogonal to the piston wall 34. Radially inboard of the outer face 40, the piston face 32 includes an upper bowl 44, and a lower bowl 46 radially inboard of the upper bowl 44. The upper bowl 44 is recessed from the outer face 40 along the piston central axis 42 in a direction toward the piston base 36. Similarly, the lower bowl 46 is recessed from the upper bowl 44 along the piston central axis 42 in a direction toward the piston base 36.

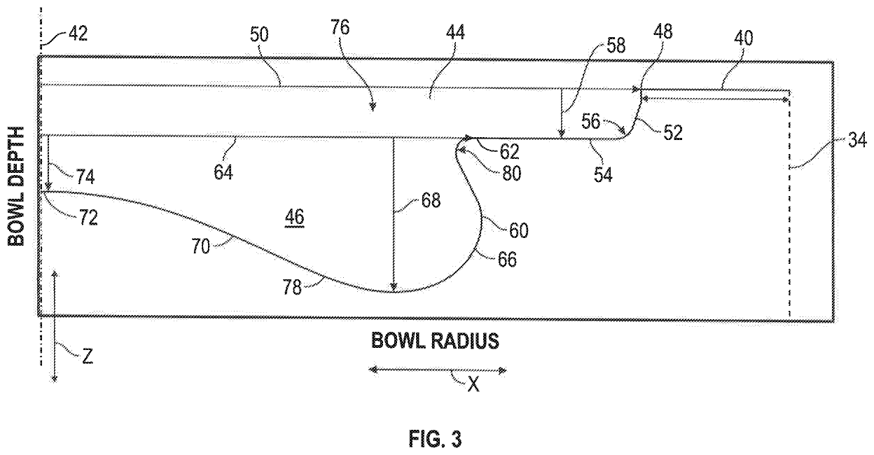

Referring to FIG. 3, each of the outer face 40, the upper bowl 44 and the lower bowl 46 are defined by surfaces centered on and axisymmetric about the piston central axis 42. The outer face 40 extends radially inwardly from the piston wall 34 to an upper bowl edge 48. The upper bowl edge 48 defines an upper bowl radius 50, which in some embodiments is in the range of 40 millimeters (1.575 inches) to 42 millimeters (1.654 inches). An upper bowl axial surface 52 extends substantially along the piston central axis 42 from the upper bowl edge 48 to an upper bowl radial surface 54. The upper bowl axial surface 52 may be connected to the upper bowl radial surface 54 by an upper connector radius 56, which in some embodiments is in the range of 0.25 millimeters (0.010 inches) to 0.45 millimeters (0.018 inches). In some embodiments, the upper bowl radial surface 54 is flat and orthogonal to the piston central axis 42. Further, the upper bowl radial surface 54 defines an upper bowl depth 58 from the outer face 40. In some embodiments, the upper bowl depth 58 is in the range of 3.5 millimeters (0.138 inches) to 4.5 millimeters (0.177 inches).

The lower bowl 46 is defined by a lower bowl surface 60 extending from the upper bowl radial surface 54. The lower bowl surface 60 intersects the upper bowl radial surface 54 at a bowl transition edge 62, and a lower bowl radius 64 is defined from the piston central axis 42 to the bowl transition edge 62. In some embodiments, the lower bowl radius 64 is in the range of 28.4 millimeters (1.157 inches) to 30.4 millimeters (1.197 inches). In some embodiments, the upper bowl radial surface 54 may be connected to the lower bowl surface 60 by a bowl transition radius 80, which in some embodiments is in the range of 0.32 millimeters (0.013 inches) to 0.52 millimeters (0.020 inches).

From the bowl transition radius 80, the lower bowl surface 60 includes a concave surface portion 66 that extends radially outwardly relative to the piston central axis 42 greater than the lower bowl radius 80. The concave surface portion 66 further extends to a maximum bowl depth 68, relative to the upper bowl axial surface 54. In some embodiments, the maximum bowl depth 68 is in the range of 10.4 millimeters (0.409 inches) to 13.4 millimeters (0.528 inches). The concave surface portion 66 is connected to a convex surface portion 70 of the lower bowl surface 60. The convex surface portion 70 extends from the concave surface portion 66 toward a lower bowl center 72. In some embodiments, the lower bowl center 72 coincides with piston central axis 42 and has a center depth 74 relative to the upper bowl axial surface 54 in the range of 3.71 millimeters (0.146 inches) to 5.71 millimeters (0.225 inches).

As stated above, the outer face 40 is a radially-extending flat surface orthogonal to the piston central axis 42, and extends between the piston wall 34 and the upper bowl edge 48. The outer face 40 has an outer face radial width 74 in the range of 9.5 millimeters (0.374 inches) to 11.5 millimeters (0.453 inches).

The upper bowl 44 and the lower bowl 46 together define a combustion bowl 76 of the piston 12, and may be represented by the cross-sectional peripheral line 78. The three-dimensional configuration of the combustion bowl 76 may be obtained by rotating the peripheral line 78 360 degrees about the piston central axis 42. The peripheral line 78 may be defined by a set of coordinate points (x₁, y₁, z₁), (x₂, y₂, z₂), . . . (xₙ, yₙ, zₙ), such as coordinate set S shown in Table 1. The values of the coordinate points in Table 1 are presented as lengths from an origin in millimeters, and represent an embodiment of a peripheral line 78. The origin is defined as the intersection of the plane containing the outer face 40 with the piston central axis 42, with the z-axis corresponding to the piston central axis 42, and the x values representing radial distances from the piston central axis 42. It is to be appreciated, however, that the coordinate points in Table 1 may be multiplied by a factor “f”, a real number greater than zero, to arrive at a scaled version of the peripheral line 78.

TABLE 1

| i | Xᵢ (mm) | Yᵢ(mm) | Zᵢ(mm) |
|---|---|---|---|
| 1 | 0.0000 | 0.0000 | −8.8295 |
| 2 | 0.2734 | 0.0000 | −8.8313 |
| 3 | 0.5467 | 0.0000 | −8.8365 |
| 4 | 0.8199 | 0.0000 | −8.8452 |
| 5 | 1.0930 | 0.0000 | −8.8573 |
| 6 | 1.3659 | 0.0000 | −8.8730 |
| 7 | 1.6385 | 0.0000 | −8.8921 |
| 8 | 1.9109 | 0.0000 | −8.9146 |
| 9 | 2.1829 | 0.0000 | −8.9407 |
| 10 | 2.4545 | 0.0000 | −8.9702 |
| 11 | 2.7257 | 0.0000 | −9.0031 |
| 12 | 2.9965 | 0.0000 | −9.0395 |
| 13 | 3.2666 | 0.0000 | −9.0793 |
| 14 | 3.5363 | 0.0000 | −9.1225 |
| 15 | 3.8052 | 0.0000 | −9.1692 |
| 16 | 4.0735 | 0.0000 | −9.2193 |
| 17 | 4.3412 | 0.0000 | −9.2724 |
| 18 | 4.6084 | 0.0000 | −9.3279 |
| 19 | 4.8750 | 0.0000 | −9.3858 |
| 20 | 5.1410 | 0.0000 | −9.4460 |
| 21 | 5.4064 | 0.0000 | −9.5085 |
| 22 | 5.6713 | 0.0000 | −9.5734 |
| 23 | 5.9355 | 0.0000 | −9.6405 |
| 24 | 6.1990 | 0.0000 | −9.7100 |
| 25 | 6.4619 | 0.0000 | −9.7819 |
| 26 | 6.7240 | 0.0000 | −9.8560 |
| 27 | 6.9855 | 0.0000 | −9.9324 |
| 28 | 7.2461 | 0.0000 | −10.0111 |
| 29 | 7.5060 | 0.0000 | −10.0921 |
| 30 | 7.7652 | 0.0000 | −10.1754 |
| 31 | 8.0235 | 0.0000 | −10.2610 |
| 32 | 8.2810 | 0.0000 | −10.3488 |
| 33 | 8.5376 | 0.0000 | −10.4389 |
| 34 | 8.7934 | 0.0000 | −10.5312 |
| 35 | 9.0482 | 0.0000 | −10.6258 |
| 36 | 9.3021 | 0.0000 | −10.7226 |
| 37 | 9.5551 | 0.0000 | −10.8217 |
| 38 | 9.8072 | 0.0000 | −10.9230 |
| 39 | 10.0582 | 0.0000 | −11.0265 |
| 40 | 10.3083 | 0.0000 | −11.1321 |
| 41 | 10.5573 | 0.0000 | −11.2400 |
| 42 | 10.8052 | 0.0000 | −11.3501 |
| 43 | 11.0521 | 0.0000 | −11.4623 |
| 44 | 11.2979 | 0.0000 | −11.5767 |
| 45 | 11.5426 | 0.0000 | −11.6933 |
| 46 | 11.7862 | 0.0000 | −11.8120 |
| 47 | 12.0286 | 0.0000 | −11.9328 |
| 48 | 12.2698 | 0.0000 | −12.0558 |
| 49 | 12.5098 | 0.0000 | −12.1809 |
| 50 | 12.7487 | 0.0000 | −12.3081 |
| 51 | 12.9862 | 0.0000 | −12.4374 |
| 52 | 13.2226 | 0.0000 | −12.5687 |
| 53 | 13.4582 | 0.0000 | −12.7013 |
| 54 | 13.6938 | 0.0000 | −12.8339 |
| 55 | 13.9295 | 0.0000 | −12.9665 |
| 56 | 14.1651 | 0.0000 | −13.0990 |
| 57 | 14.4007 | 0.0000 | −13.2315 |
| 58 | 14.6363 | 0.0000 | −13.3641 |
| 59 | 14.8719 | 0.0000 | −13.4966 |
| 60 | 15.1075 | 0.0000 | −13.6292 |
| 61 | 15.3431 | 0.0000 | −13.7618 |
| 62 | 15.5788 | 0.0000 | −13.8943 |
| 63 | 15.8144 | 0.0000 | −14.0269 |
| 64 | 16.0500 | 0.0000 | −14.1595 |
| 65 | 16.2857 | 0.0000 | −14.2920 |
| 66 | 16.5213 | 0.0000 | −14.4246 |
| 67 | 16.7568 | 0.0000 | −14.5572 |
| 68 | 16.9924 | 0.0000 | −14.6896 |
| 69 | 17.2281 | 0.0000 | −14.8222 |
| 70 | 17.4637 | 0.0000 | −14.9548 |
| 71 | 17.6993 | 0.0000 | −15.0874 |
| 72 | 17.9350 | 0.0000 | −15.2199 |
| 73 | 18.1720 | 0.0000 | −15.3501 |
| 74 | 18.4112 | 0.0000 | −15.4765 |
| 75 | 18.6527 | 0.0000 | −15.5991 |
| 76 | 18.8963 | 0.0000 | −15.7178 |
| 77 | 19.1419 | 0.0000 | −15.8324 |
| 78 | 19.3895 | 0.0000 | −15.9432 |
| 79 | 19.6391 | 0.0000 | −16.0500 |
| 80 | 19.8905 | 0.0000 | −16.1527 |
| 81 | 20.1437 | 0.0000 | −16.2514 |
| 82 | 20.3985 | 0.0000 | −16.3460 |
| 83 | 20.6550 | 0.0000 | −16.4365 |
| 84 | 20.9130 | 0.0000 | −16.5228 |
| 85 | 21.1725 | 0.0000 | −16.6050 |
| 86 | 21.4334 | 0.0000 | −16.6830 |
| 87 | 21.6956 | 0.0000 | −16.7568 |
| 88 | 21.9591 | 0.0000 | −16.8264 |
| 89 | 22.2239 | 0.0000 | −16.8917 |
| 90 | 22.4907 | 0.0000 | −16.9486 |
| 91 | 22.7599 | 0.0000 | −16.9942 |
| 92 | 23.0309 | 0.0000 | −17.0282 |
| 93 | 23.3032 | 0.0000 | −17.0506 |
| 94 | 23.5764 | 0.0000 | −17.0613 |
| 95 | 23.8497 | 0.0000 | −17.0603 |
| 96 | 24.1227 | 0.0000 | −17.0477 |
| 97 | 24.3949 | 0.0000 | −17.0233 |
| 98 | 24.6656 | 0.0000 | −16.9873 |
| 99 | 24.9345 | 0.0000 | −16.9397 |
| 100 | 25.2008 | 0.0000 | −16.8808 |
| 101 | 25.4641 | 0.0000 | −16.8105 |
| 102 | 25.7238 | 0.0000 | −16.7290 |
| 103 | 25.9794 | 0.0000 | −16.6365 |
| 104 | 26.2305 | 0.0000 | −16.5331 |
| 105 | 26.4765 | 0.0000 | −16.4192 |
| 106 | 26.7169 | 0.0000 | −16.2948 |
| 107 | 26.9513 | 0.0000 | −16.1603 |
| 108 | 27.1791 | 0.0000 | −16.0158 |
| 109 | 27.3999 | 0.0000 | −15.8617 |
| 110 | 27.6134 | 0.0000 | −15.6984 |
| 111 | 27.8188 | 0.0000 | −15.5262 |
| 112 | 28.0162 | 0.0000 | −15.3452 |
| 113 | 28.2048 | 0.0000 | −15.1560 |
| 114 | 28.3844 | 0.0000 | −14.9590 |
| 115 | 28.5545 | 0.0000 | −14.7544 |
| 116 | 28.7149 | 0.0000 | −14.5428 |
| 117 | 28.8654 | 0.0000 | −14.3245 |
| 118 | 29.0053 | 0.0000 | −14.1001 |
| 119 | 29.1347 | 0.0000 | −13.8698 |
| 120 | 29.2532 | 0.0000 | −13.6342 |
| 121 | 29.3605 | 0.0000 | −13.3939 |
| 122 | 29.4565 | 0.0000 | −13.1492 |
| 123 | 29.5410 | 0.0000 | −12.9006 |
| 124 | 29.6137 | 0.0000 | −12.6487 |
| 125 | 29.6744 | 0.0000 | −12.3939 |
| 126 | 29.7233 | 0.0000 | −12.1367 |
| 127 | 29.7602 | 0.0000 | −11.8777 |
| 128 | 29.7848 | 0.0000 | −11.6174 |
| 129 | 29.7972 | 0.0000 | −11.3563 |
| 130 | 29.7976 | 0.0000 | −11.0949 |
| 131 | 29.7871 | 0.0000 | −10.8338 |
| 132 | 29.7658 | 0.0000 | −10.5732 |
| 133 | 29.7338 | 0.0000 | −10.3136 |
| 134 | 29.6913 | 0.0000 | −10.0554 |
| 135 | 29.6382 | 0.0000 | −9.7990 |
| 136 | 29.5746 | 0.0000 | −9.5448 |
| 137 | 29.5007 | 0.0000 | −9.2932 |
| 138 | 29.4165 | 0.0000 | −9.0445 |
| 139 | 29.3222 | 0.0000 | −8.7992 |
| 140 | 29.2218 | 0.0000 | −8.5560 |
| 141 | 29.1215 | 0.0000 | −8.3129 |
| 142 | 29.0212 | 0.0000 | −8.0697 |
| 143 | 28.9209 | 0.0000 | −7.8266 |
| 144 | 28.8206 | 0.0000 | −7.5834 |
| 145 | 28.7203 | 0.0000 | −7.3403 |
| 146 | 28.6200 | 0.0000 | −7.0971 |
| 147 | 28.5198 | 0.0000 | −6.8540 |
| 148 | 28.4236 | 0.0000 | −6.6093 |
| 149 | 28.3356 | 0.0000 | −6.3618 |
| 150 | 28.2560 | 0.0000 | −6.1118 |
| 151 | 28.1846 | 0.0000 | −5.8595 |
| 152 | 28.1217 | 0.0000 | −5.6051 |
| 153 | 28.0800 | 0.0000 | −5.3471 |
| 154 | 28.0963 | 0.0000 | −5.0868 |
| 155 | 28.1722 | 0.0000 | −4.8362 |
| 156 | 28.3039 | 0.0000 | −4.6077 |
| 157 | 28.4849 | 0.0000 | −4.4126 |
| 158 | 28.7064 | 0.0000 | −4.2602 |
| 159 | 28.9575 | 0.0000 | −4.1582 |
| 160 | 29.2259 | 0.0000 | −4.1115 |
| 161 | 29.4992 | 0.0000 | −4.1087 |
| 162 | 29.7726 | 0.0000 | −4.1087 |
| 163 | 30.0460 | 0.0000 | −4.1087 |
| 164 | 30.3193 | 0.0000 | −4.1087 |
| 165 | 30.5928 | 0.0000 | −4.1087 |
| 166 | 30.8661 | 0.0000 | −4.1087 |
| 167 | 31.1395 | 0.0000 | −4.1087 |
| 168 | 31.4129 | 0.0000 | −4.1087 |
| 169 | 31.6863 | 0.0000 | −4.1087 |
| 170 | 31.9596 | 0.0000 | −4.1087 |
| 171 | 32.2330 | 0.0000 | −4.1087 |
| 172 | 32.5064 | 0.0000 | −4.1087 |
| 173 | 32.7798 | 0.0000 | −4.1087 |
| 174 | 33.0531 | 0.0000 | −4.1087 |
| 175 | 33.3266 | 0.0000 | −4.1087 |
| 176 | 33.5999 | 0.0000 | −4.1087 |
| 177 | 33.8733 | 0.0000 | −4.1087 |
| 178 | 34.1466 | 0.0000 | −4.1087 |
| 179 | 34.4201 | 0.0000 | −4.1087 |
| 180 | 34.6934 | 0.0000 | −4.1087 |
| 181 | 34.9668 | 0.0000 | −4.1087 |
| 182 | 35.2402 | 0.0000 | −4.1087 |
| 183 | 35.5136 | 0.0000 | −4.1087 |
| 184 | 35.7869 | 0.0000 | −4.1087 |
| 185 | 36.0604 | 0.0000 | −4.1087 |
| 186 | 36.3337 | 0.0000 | −4.1087 |
| 187 | 36.6071 | 0.0000 | −4.1087 |
| 188 | 36.8804 | 0.0000 | −4.1087 |
| 189 | 37.1539 | 0.0000 | −4.1087 |
| 190 | 37.4272 | 0.0000 | −4.1087 |
| 191 | 37.7006 | 0.0000 | −4.1087 |
| 192 | 37.9740 | 0.0000 | −4.1087 |
| 193 | 38.2474 | 0.0000 | −4.1087 |
| 194 | 38.5207 | 0.0000 | −4.1087 |
| 195 | 38.7941 | 0.0000 | −4.1087 |
| 196 | 39.0667 | 0.0000 | −4.0938 |
| 197 | 39.3296 | 0.0000 | −4.0242 |
| 198 | 39.5700 | 0.0000 | −3.9010 |
| 199 | 39.7763 | 0.0000 | −3.7302 |
| 200 | 39.9382 | 0.0000 | −3.5203 |
| 201 | 40.0478 | 0.0000 | −3.2814 |
| 202 | 40.1196 | 0.0000 | −3.0292 |
| 203 | 40.1903 | 0.0000 | −2.7767 |
| 204 | 40.2610 | 0.0000 | −2.5242 |
| 205 | 40.3318 | 0.0000 | −2.2717 |
| 206 | 40.4025 | 0.0000 | −2.0193 |
| 207 | 40.4734 | 0.0000 | −1.7668 |
| 208 | 40.5441 | 0.0000 | −1.5143 |
| 209 | 40.6148 | 0.0000 | −1.2618 |
| 210 | 40.6495 | 0.0000 | −1.0048 |
| 211 | 40.6495 | 0.0000 | −0.7434 |
| 212 | 40.6495 | 0.0000 | −0.4820 |
| 213 | 40.6495 | 0.0000 | −0.2206 |
| 214 | 40.6921 | 0.0000 | 0.0000 |

It should be understood that in some embodiments, the peripheral line 78 may be defined by fewer than all of the coordinate points of Table 1.

The piston 12 configurations presented herein, including the combustion bowl 76 achieves simultaneous reduction of soot and NOx emissions by providing enhanced mixing of combustion products with excess air available in the cylinder 26. Further, the combustion bowl 76 achieves this reduction of soot and NOx emissions while also maintaining or improving fuel consumption using conventional fuel injection and air handling equipment. The reduction of soot further achieves the benefit of keeping the engine oil cleaner.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A piston for an internal combustion engine, comprising:
a piston wall defining an outer perimeter of the piston;
a piston face disposed at an end of the piston wall, the piston face including:
a radially-extending outer face; and
a combustion bowl formed therein and recessed from the outer face, the combustion bowl including:
an upper bowl including a flat upper bowl axial surface recessed from the outer face a distance in the range from 3.5 to 4.5 millimeters; and
a lower bowl including a lower bowl surface recessed to a maximum bowl depth from the flat upper bowl axial surface in the range from 10.4 to 13.4 millimeters;
wherein the piston face is axisymmetric about a piston central axis.

2. The piston of claim 1, wherein the upper bowl radial surface is orthogonal to the piston central axis.

3. The piston of claim 1, wherein the lower bowl is defined by a lower bowl surface including:
a concave surface portion; and
a convex surface portion extending from the concave surface portion toward the piston central axis, wherein the maximum bowl depth is located in the concave surface portion.

4. The piston of claim 3, wherein the lower bowl surface is connected to the upper bowl axial surface via a bowl transition radius in the range of 0.32 to 0.52 millimeters.

5. The piston of claim 4, wherein the intersection of the bowl transition radius to the upper bowl axial surface defines a lower bowl radius from the piston central axis in the range of 28.4 to 30.4 millimeters.

6. The piston of claim 5, wherein the concave surface portion extends radially outwardly from the piston central axis further that the lower bowl radius.

7. The piston of claim 1, wherein the radially-extending outer face intersects the upper bowl at an upper bowl edge, the upper bowl edge defining an upper bowl radius in the range of 40 to 42 millimeters relative to the piston central axis.

8. The piston of claim 7, wherein an upper bowl axial surface extends from the upper bowl edge toward the upper bowl radial surface and is connected thereto by an upper connector radius in the range of 0.25 to 0.45 millimeters.

9. The piston of claim 1, wherein the lower bowl has a lower bowl center located at the piston central axis, the lower bowl center having a center depth relative to the upper bowl axial surface in the range of 3.71 to 5.71 millimeters.

10. The piston of claim 1, wherein the radially-extending outer face extends radially from the combustion bowl to the piston wall and has a radial width in the range of 9.5 millimeters to 11.5 millimeters.

11. The piston of claim 1, wherein the radially-extending outer face is orthogonal to the piston central axis.

12. The piston of claim 1, wherein the combustion bowl is defined by revolving a set of coordinate points 360 degrees about the piston central axis, the set of coordinate points defined in Table 1.

13. A piston, comprising:
a piston face; and
a combustion bowl formed in the piston face and recessed therefrom, the combustion bowl including:
an upper bowl having an upper bowl radius at the piston face in the range of 40 to 42 millimeters, the upper bowl including a flat upper bowl axial surface recessed from the piston face; and
a lower bowl recessed from the upper bowl having a lower bowl radius at the upper bowl in the range of 28.4 to 30.4 millimeters;
wherein the lower bowl includes a lower bowl surface recessed to a maximum bowl depth from the flat upper bowl axial surface in the range from 10.4 to 13.4 millimeters.

14. The piston of claim 13, wherein the upper bowl a flat upper bowl radial surface recessed from the piston face a distance in the range from 3.5 to 4.5 millimeters.

15. The piston of claim 14, wherein the upper bowl radial surface is orthogonal to the piston central axis.

16. (canceled)

17. The piston of claim 13, wherein the lower bowl surface includes:
a concave surface portion; and
a convex surface portion extending from the concave surface portion toward the piston central axis;
wherein the maximum bowl depth is located in the concave surface portion.

18. The piston of claim 17, wherein the lower bowl surface is connected to the upper bowl via a bowl transition radius in the range of 0.32 to 0.52 millimeters.

19. The piston of claim 13, wherein the lower bowl has a lower bowl center located at the piston central axis, the lower bowl center having a center depth relative to the upper bowl radial surface in the range of 3.71 to 5.71 millimeters.

20. A piston, comprising:
a piston wall defining an outer perimeter of the piston;
a piston face disposed at an end of the piston wall, the piston face including:
an outer face; and
a combustion bowl formed therein and recessed from the outer face, the combustion bowl is defined by revolving a set of coordinate points 360 degrees about a piston central axis, the set of coordinate points defined in Table 1.
